(19) United States
(12) Patent Application Publication
(10) Pub. No.: US 2009/0282673 A1
(43) Pub. Date: Nov. 19, 2009

(54) Device for locking lens

(75) Inventors: Chih-Ming Huang, Hsin-Chu (TW); Chih-Lun Chen, Hsin-Chu (TW)

Correspondence Address: Haverstock & Owens LLP, 162 North Wolfe Road, Sunnyvale, CA, 94086, US

(73) Assignee: Mustek Systems Inc.

(21) Appl. No.: 12/316,750

(22) Filed: Dec. 15, 2008

(30) Foreign Application Priority Data
May 15, 2008 (TW) 097208494

(51) Int. Cl. G02B 7/04

(52) U.S. Cl. 29/700; 359/814

(57) ABSTRACT

A lens-fastening apparatus for assembling a voice coil motor of a camera module is provided. The voice coil motor has a lens holder. The lens-fastening apparatus includes a guiding plate; a rotation stopping jig having a central and a lateral portions, disposed on the guiding plate, and fit with the lens holder for stopping a rotation of the lens holder; a focusing ring for rotating the lens; a first pressing device pressing the central portion of the rotation stopping jig to fasten the rotation stopping jig on the guiding plate; and a second pressing device pressing the lateral portion of the rotation stopping jig.

### FIELD OF THE INVENTION

The present invention relates to a lens-fastening apparatus for assembling a voice coil motor of a camera module, and more particularly to a lens-fastening apparatus for assembling a voice coil motor with a lens holder.

### BACKGROUND OF THE INVENTION

There is a voice coil motor (VCM) in each of the regular compact camera modules for cellular phones. The VCM has been an auto-focus solution of the smallest dimension with the lowest cost in the market. Since the quality of image of cellular phones with compact camera modules has been improved continuously, the pixel quality of the camera modules becomes the most critical factor. Therefore the pixel quality needs to be adjusted to the best condition when the lens is being focused in the production line. However, there exists an issue of lacking stability for the operation of the current rotation stopping jigs. Please refer to FIG. 1, which is a cross section diagram of the prior art. It can be observed that four spring plates 10 and a lens holder 11 of a voice coil motor are located at the lower potion of the diagram. The assembly operators need to make use of a lens locking apparatus 16, comprising a rotation-stopping jig 13, to keep the lens holder 11 free of rotation. The process is to plug the 3-4 guiding pins 14 of the rotation-stopping jig 13 into the four guiding holes 15 in the lens holder with bare hands, and then to screw the lens 12 into the housing.

Please refer to FIG. 2, which shows a coil motor 24 fastened on a base plate 23. The operators may make use of a lens fastening apparatus 20 having a rotary guiding plate 21, to carry the rotation-stopping jig 13. The rotation-stopping jig 13 is placed into a concave area 22 of the rotary guiding plate 21. When the rotary guiding plate 21 is moved toward the top of the base plate 23, a guiding pin 141 at the lower side of the rotation-stopping jig 13 will firstly contact the guiding hole 151 of the lens house, in which the guiding hole 151 is positioned relatively closer to the axis of the rotary guiding plate 21 than the others. And a guiding pin 142 at the higher side of the rotation-stopping jig 13 will then contact the guiding hole 152. Thus, the rotation-stopping jig 13 is assembled to the lens holder 11 in a separate process, which will result in unbalance of stressing and difficult in jointing the two parts together. Even worse, deformation might occur to the spring plates 10 and eventually damage the VCM. Therefore, there exists a large room for improvement regarding the assembly of the rotation-stopping jig and the lens holder.

### SUMMARY OF THE INVENTION

To overcome the abovementioned issues, the present invention provides a lens-fastening apparatus for assembling a voice coil motor of a camera module. The voice coil motor has a lens holder. The lens-fastening apparatus includes a guiding plate, a rotation-stopping jig, a focus ring for rotating the lens, a first pressing device and a second pressing device. The rotation-stopping jig has a central portion and a lateral portion, disposed on the guiding plate, and fit with the lens holder for stopping a rotation of the lens holder. The first pressing device presses the central portion of the rotation-stopping jig to fasten the rotation-stopping jig on the guiding plate. The second pressing device presses the lateral portion of the rotation-stopping jig.

In accordance with the abovementioned lens-fastening apparatus, the first pressing device has a protrusion portion for pressing the central portion of the rotation-stopping jig.

Preferably, the first pressing device has an elastic element for producing an elastic force to press the rotation-stopping jig.

Preferably, the first pressing device includes a slider having a sliding end, and when the first pressing device presses the central portion of the rotation-stopping jig, the slider is pushed and moved upward, and the sliding end compresses the elastic element to produce the elastic force.

Preferably, the first pressing device has an assembly rod for assembling the elastic element and positioning the sliding end, and the slider has a central sliding shaft sliding in a central hole of the first pressing device.

Preferably, the first pressing device has an inverted U shape to accommodate the central portion of the rotation-stopping jig.

Preferably, the first pressing device is guided onto the rotation-stopping jig around an axis.

Preferably, the first pressing device has a protrusion tenon fitting into a mortise of the guiding plate.

Preferably, the protrusion tenon of the first pressing device has a separation plate for loosening the tenon so as to separate the first pressing device away from the guiding plate.

Preferably, the second pressing device has a first and a second pressing portions for pressing the rotation-stopping jig.

Preferably, the second pressing device is fastened on the guiding plate by a screw.

Preferably, the second pressing device has a U shape viewed from a top thereof to accommodate a positioning rod for positioning the rotation-stopping jig.

Preferably, the second pressing device has a U shape when viewed from a lateral thereof to accommodate the lateral portion of the rotation-stopping jig.

In accordance with another aspect of the present invention, a lens-fastening apparatus for assembling a voice coil motor of a camera module is provided. The voice coil motor has a lens holder. The lens-fastening apparatus includes a rotation-stopping device and a first pressing device. The rotation-stopping device has a central portion, disposed on the lens holder, and fit with the lens holder for stopping a rotation of the lens holder; and the first pressing device is for pressing the central portion of the rotation-stopping device to fasten the lens holder on the rotation-stopping device.

In accordance with the same aspect of the present invention, the rotation-stopping device further includes a rotation-stopping jig and a guiding plate. The rotation-stopping jig is disposed on the guiding plate and is fit with the lens holder. The central portion is located at the rotation-stopping jig. And the lens-fastening apparatus further comprises a second pressing device disposed on the guiding plate for pressing a lateral portion of the rotation-stopping jig.

Preferably, the first pressing device has an elastic element for producing an elastic force to press the rotation-stopping jig.

Preferably, the first pressing device has an elastic element for producing an elastic force to press the rotation-stopping jig.

In accordance with another aspect of the present invention, a lens-fastening apparatus for assembling a voice coil motor of a camera module is provided. The voice coil motor has a lens holder. The lens-fastening apparatus includes a rotation-stopping device and a first pressing device. The rotation-stopping device is disposed on the lens holder and fit with the lens holder for stopping a rotation of the lens holder. And the first pressing device is for pressing a lateral portion of the rotation-stopping device to fasten the lens holder on the rotation-stopping device.

Preferably, the rotation-stopping device further includes a rotation-stopping jig and a guiding plate. The rotation-stopping jig is disposed on the guiding plate and is fit with the lens holder, and the lens-fastening apparatus further comprises a second pressing device located at the rotation guiding plate for pressing a central portion of the rotation-stopping jig.

Preferably, the first pressing device has a first and a second pressing portions for pressing the rotation-stopping jig.

The above objects and advantages of the present invention will become more readily apparent to those ordinarily skilled in the art after reading the details set forth in the descriptions and drawings that follow, in which:

### BRIEF DESCRIPTION OF THE DRAWINGS

FIG. 1 is a schematic diagram showing the cross-section of the lens holder and rotation-stopping jig in the prior art;

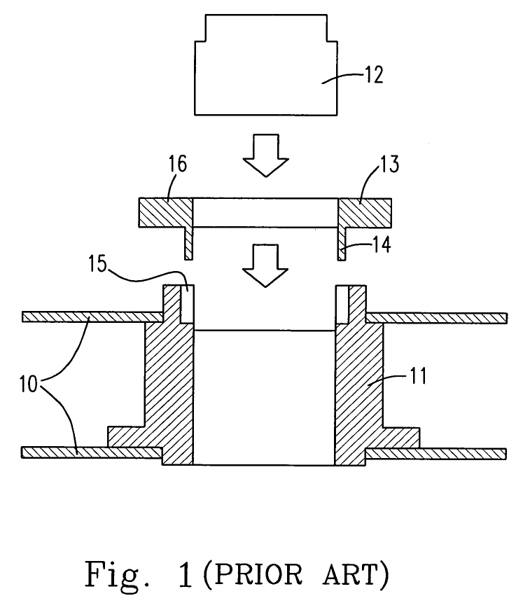

FIG. 2 is a schematic diagram showing a coil motor fastened on a base plate, a rotary guiding plate and a rotation-stopping jig in the prior art;

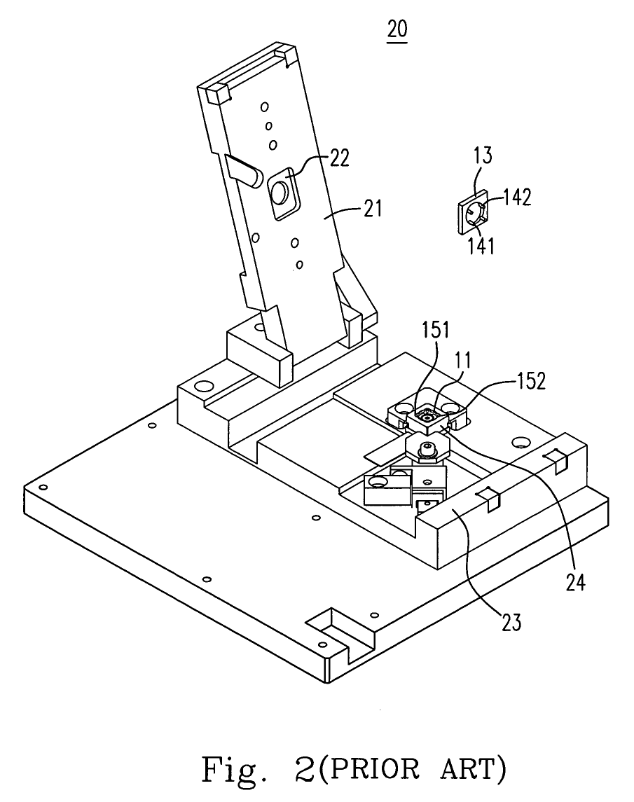

FIG. 3 is a top view of a lens-fastening apparatus for assembling a voice coil motor of a camera module, after completion of the assembly, according to a preferred embodiment of the present invention;

FIG. 4 is a schematic diagram showing the lens-fastening apparatus for assembling a voice coil motor of a camera module, before the assembly of the rotary guiding plate and the base plate, according to a preferred embodiment of the present invention;

FIG. 5 is a schematic diagram showing the lens-fastening apparatus for assembling a voice coil motor of a camera module, after the assembly of the rotary guiding plate and the base plate and before that of the pressing device and the rotary guiding plate, according to a preferred embodiment of the present invention;

FIG. 6 is a schematic diagram showing the focusing ring and the elastic elements, according to a preferred embodiment of the present invention;

FIG. 7 is a top view of a lens-fastening apparatus for assembling a voice coil motor of a camera module, after completion of the assembly, according to a preferred embodiment of the present invention;

FIG. 8 is a schematic diagram showing a lens-fastening apparatus for assembling a voice coil motor of a camera module, after completion of the assembly, according to a preferred embodiment of the present invention; and

FIG. 9 is a side view of a lens-fastening apparatus for assembling a voice coil motor of a camera module, after completion of the assembly, according to a preferred embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; it is not intended to be exhaustive or to be limited to the precise form disclosed.

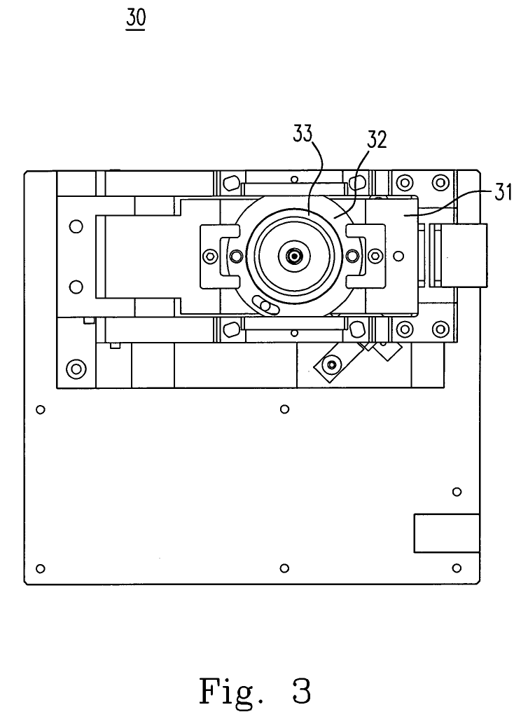

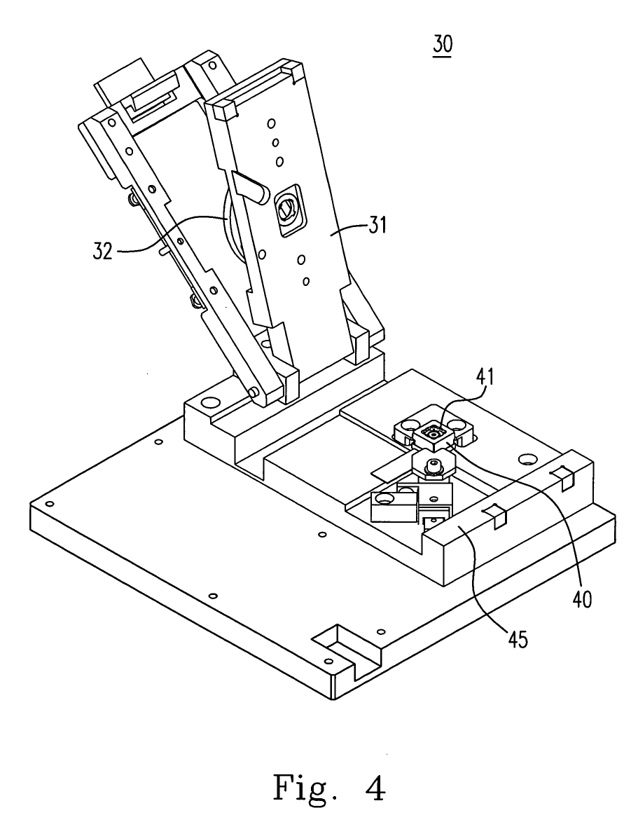

Please refer to FIG. 3, which is a top view of a lens-fastening apparatus 30 for assembling a voice coil motor of a camera module. The lens-fastening apparatus 30 comprises a rotary guiding plate 31, a rotation-stopping jig 32, and a focusing ring 33, which is fit on top of a lens 12 and is for rotating the lens 12. Referring to FIG. 4, there shows the lens-fastening apparatus 30 for assembling a vice coil motor 40 of a compact camera module for cell phones. The voice coil motor 40 has a lens holder 41 for providing the locating of the lens 12. A rotation-stopping jig 32 is furnished on the rotary guiding plate 31. The rotary guiding plate 31 is rotated toward the top of a base plate 45. The rotation-stopping jig 32 contacts the lens holder 41 for holding a rotation of the lens holder 41.

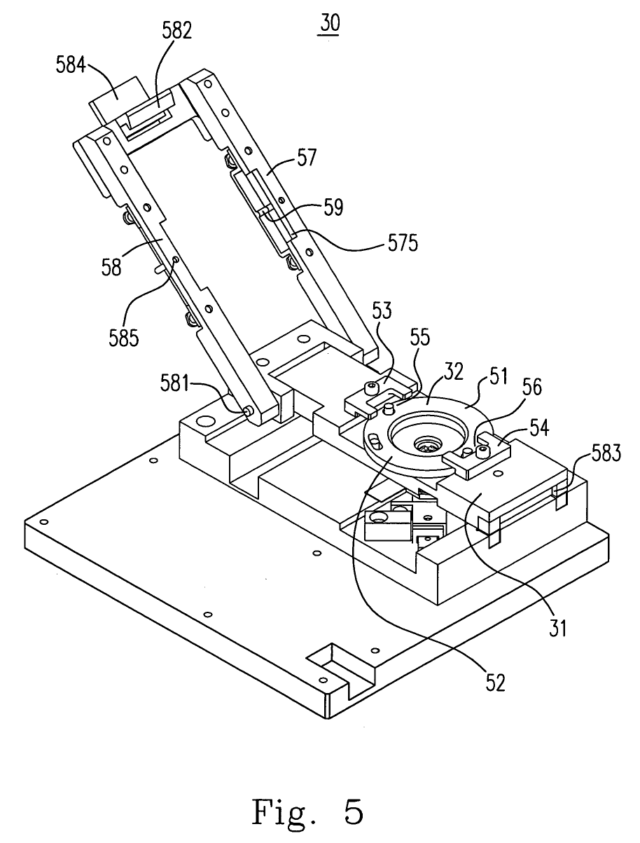

Please refer to FIG. 5, there shows the rotation-stopping jig 32 having two central portions 51 and 52. The lens-fastening apparatus 30 has two lateral pressing elements 53 and 54 for pressing two lateral portions 55 and 56 of the rotation-stopping jig 32, and two central pressing elements 57 and 58 for pressing the central portions 51 and 52, to fasten the rotation-stopping jig 32 onto the rotary guiding plate 31.

The central pressing element 57 has a protrusion portion 59 and a central concave portion 575. The protrusion portion 59 is for pressing the central portion 51 of the rotation-stopping jig 32. The central pressing element 58 adopts an axis 581 to rotate the central pressing element 58 onto the rotation-stopping jig 32. The two central pressing elements 57 and 58 adopt a protrusion tenon 582, fitting into a mortise 583, to be fastened on the rotary guiding plate 31. The protrusion tenon 582 may further be furnished with a separation plate 584 for loosening the protrusion tenon 582 so as to separate the central pressing elements 57 and 58 away from the rotary guiding plate 31. The lateral pressing elements 53 and 54 may further have a γ shape when viewed from a lateral thereof, to accommodate the lateral portions 55 and 56 of the rotation-stopping jig 32.

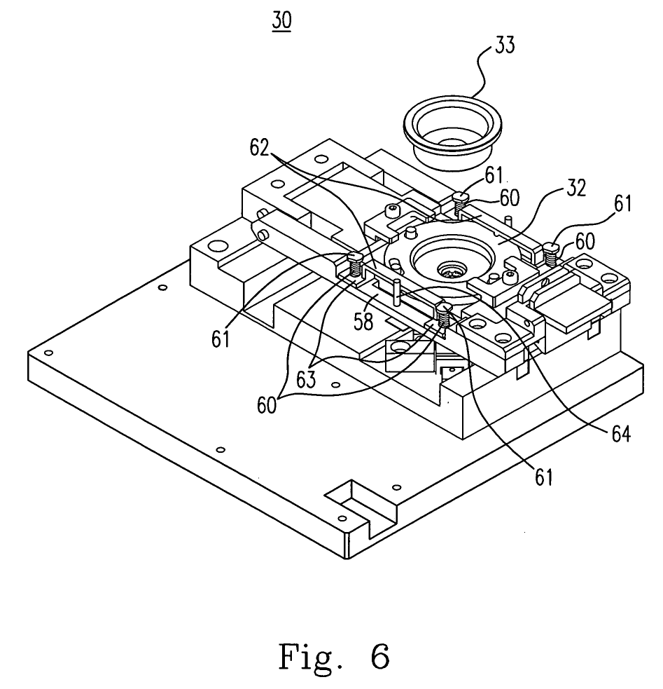

Please refer to FIG. 6, wherein the central pressing elements 57 and 58 are furnished with four elastic components 60 (for example, a spring), to produce an elastic force for pressing the rotation-stopping jig 32. The central pressing elements 57 and 58 are also furnished with two sliders 62, in which each slider 62 has two sliding ends 63. The central pressing elements 57 and 58 may adopt four assembly rods 61 to assemble the elastic components 60 and position the sliding ends 63. Each of the sliders 62 has a central sliding shaft 64 sliding in a central hole 585 of the central pressing element 57 or 58.

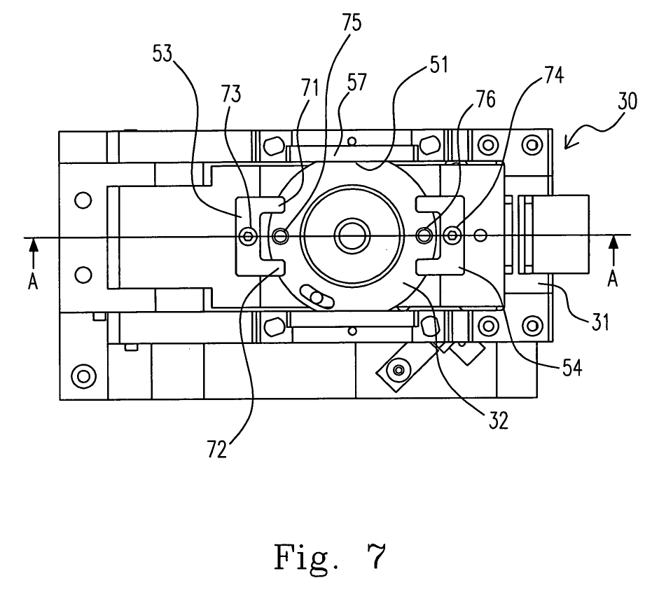

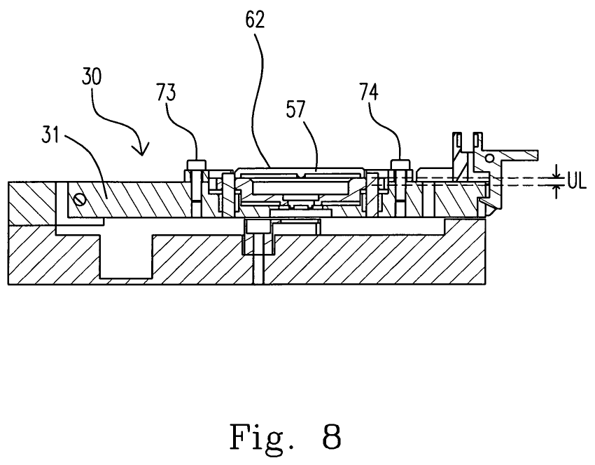

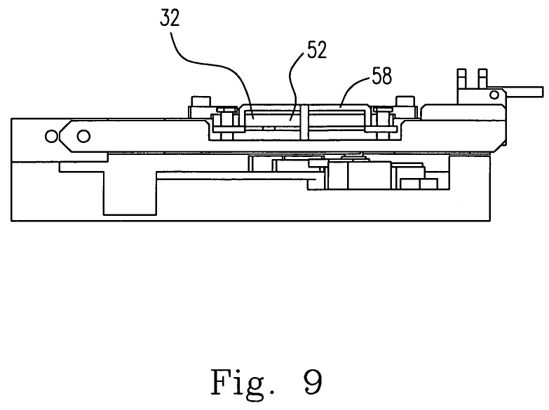

Please refer to FIG. 7, which shows a top view of the assembly of the central pressing elements 57 and 58 with the rotation-stopping jig 32. The lateral pressing element 53 has a first and a second pressing portions 71 and 72, for pressing the rotation-stopping jig 32. The lateral pressing elements 53 and 54 adopt two screws 73 and 74 to fasten the lateral pressing elements 53 and 54 on the rotary guiding plate 31. The lateral pressing elements 53 and 54 have a U shape viewed from a top thereof to accommodate positioning rods 75 and 76 respectively, for positioning the rotation-stopping jig 32. Please refer to FIG. 8, wherein the slider 62 is pushed upward by the central portion 51 to a distance UL when the central pressing element 57 presses the central portion 51 downward, and meanwhile, the sliding end 63 presses the elastic component 60. Referring to FIG. 9, the central pressing element 58 has an inverted U shape to accommodate the central portion 52 of the rotation-stopping jig 32.

In accordance with another technical aspect, the present invention provides a lens-fastening apparatus 30 for assembling a vice coil motor 40 of a compact camera module usually for cell phones. The voice coil motor 40 has a lens holder 41 for providing the locating of a lens 12. The lens-fastening apparatus 30 comprises a rotation-stopping device (say a rotary guiding plate 31 together with a rotation-stopping jig 32) disposed on top of a lens holder 41. The rotation-stopping device is fit with the lens holder 41 to keep the lens holder 41 free of rotation, and has two central pressing elements 57 and 58 for pressing two central portions 51 and 52 respectively to fasten the lens holder 41 with the rotation-stopping device. Now taking the rotation-stopping device of the lens-fastening apparatus 30 comprising a rotary guiding plate 31 and a rotation-stopping jig 32 for example, the rotation-stopping jig 32 is furnished on the rotary guiding plate 31, fit with the lens holder 41, and having two central portions 51 and 52. The lens-fastening apparatus 30 further comprises lateral pressing devices 53 and 54, which are disposed on the rotary guiding plate 31 for pressing lateral portions 55 and 56 of the rotation-stopping jig 32. Other details regarding the lens-fastening apparatus 30 will not be repeated here.

In accordance with another practical aspect, the present invention provides a lens-fastening apparatus 30 for assembling a vice coil motor 40 of a compact camera module usually for cell phones. The voice coil motor 40 has a lens holder 41 for providing the locating of a lens 12. The lens-fastening apparatus 30 comprises a rotation-stopping device (say a rotary guiding plate 31 together with a rotation-stopping jig 32) disposed on top of a lens holder 41. The rotation-stopping device is fit with the lens holder 41 to keep the lens holder 41 free of rotation, and has two lateral pressing elements 53 and 54 for pressing two lateral portions 53 and 54 respectively to fasten the lens holder 41 with the rotation-stopping device. Now taking the rotation-stopping device of the lens-fastening apparatus 30 comprising a rotary guiding plate 31 and a rotation-stopping jig 32 for example, the rotation-stopping jig 32 is furnished on the rotary guiding plate 31, fit with the lens holder 41, and having two lateral portions 55 and 56. The lens-fastening apparatus 30 further comprises central pressing devices 57 and 58 for pressing central portions 51 and 52 of the rotation-stopping jig 32. Other details regarding the lens-fastening apparatus 30 will not be repeated here.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims that are to be accorded with the broadest interpretation so as to encompass all such modifications and similar structures.

### Attachment

### Attorneys Of Haverstock & Owens LLP

| | |
|---|---|
| Thomas B. Haverstock | Reg. No. 32,571 |
| Jonathan O. Owens | Reg. No. 37,902 |
| David A. Hill | Reg. No. 44,153 |
| Jack R. Harris | Reg. No. 51,145 |
| Lucas Myslinski | Reg. No. 56,418 |

What is claimed is:

1. A lens-fastening apparatus for assembling a voice coil motor of a camera module, wherein the voice coil motor has a lens holder, comprising:
a guiding plate;
a rotation stopping jig having a central and a lateral portions, disposed on the guiding plate, and fit with the lens holder for stopping a rotation of the lens holder;
a focusing ring for rotating the lens;
a first pressing device pressing the central portion of the rotation stopping jig to fasten the rotation stopping jig on the guiding plate; and
a second pressing device pressing the lateral portion of the rotation stopping jig.

2. An apparatus as claimed in claim 1, wherein the first pressing device has a protrusion portion for pressing the central portion of the rotation-stopping jig.

3. An apparatus as claimed in claim 2, wherein the first pressing device has an elastic element for producing an elastic force to press the rotation-stopping jig.

4. An apparatus as claimed in claim 3, wherein the first pressing device includes a slider having a sliding end, and when the first pressing device presses the central portion of the rotation-stopping jig, the slider is pushed and moved upward, and the sliding end compresses the elastic element to produce the elastic force.

5. An apparatus as claimed in claim 4, wherein the first pressing device has an assembly rod for assembling the elastic element and positioning the sliding end, and the slider has a central sliding shaft sliding in a central hole of the first pressing device.

6. An apparatus as claimed in claim 1, wherein the first pressing device has an inverted U shape to accommodate the central portion of the rotation-stopping jig.

7. An apparatus as claimed in claim 1, wherein the first pressing device is guided onto the rotation-stopping jig around an axis.

8. An apparatus as claimed in claim 1, wherein the first pressing device has a protrusion tenon fitting into a mortise of the guiding plate.

9. An apparatus as claimed in claim 8, wherein the protrusion tenon of the first pressing device has a separation plate for loosening the tenon so as to separate the first pressing device away from the guiding plate.

10. An apparatus as claimed in claim 1, wherein the second pressing device has a first and a second pressing portions for pressing the rotation-stopping jig.

11. An apparatus as claimed in claim 10, wherein the second pressing device is fastened on the guiding plate by a screw.

12. An apparatus as claimed in claim 1, wherein the second pressing device has a U shape viewed from a top thereof to accommodate a positioning rod for positioning the rotation-stopping jig.

13. An apparatus as claimed in claim 1, wherein the second pressing device has a γ shape when viewed from a lateral thereof to accommodate the lateral portion of the rotation-stopping jig.

14. A lens-fastening apparatus for assembling a voice coil motor of a camera module, wherein the voice coil motor has a lens holder, comprising:
a rotation-stopping device having a central portion, disposed on the lens holder, and fit with the lens holder for stopping a rotation of the lens holder; and
a first pressing device for pressing the central portion of the rotation-stopping device to fasten the lens holder on the rotation-stopping device.

15. An apparatus as claimed in claim 14, wherein the rotation-stopping device comprises a rotation-stopping jig and a guiding plate, the rotation-stopping jig is disposed on the guiding plate and is fit with the lens holder, the central portion is located at the rotation-stopping jig, and the lens-fastening apparatus further comprises a second pressing device disposed on the guiding plate for pressing a lateral portion of the rotation-stopping jig.

16. An apparatus as claimed in claim 15, wherein the first pressing device has an elastic element for producing an elastic force to press the rotation-stopping jig.

17. An apparatus as claimed in claim 15, wherein the first pressing device has a protrusion portion for pressing the central portion of the rotation-stopping jig.

18. A lens-fastening apparatus for assembling a voice coil motor of a camera module, wherein the voice coil motor has a lens holder, comprising:
a rotation-stopping device disposed on the lens holder, and fit with the lens holder for stopping a rotation of the lens holder; and
a first pressing device for pressing a lateral portion of the rotation-stopping device to fasten the lens holder on the rotation-stopping device.

19. An apparatus as claimed in claim 18, wherein the rotation-stopping device comprises a rotation-stopping jig and a guiding plate, the rotation-stopping jig is disposed on the guiding plate and is fit with the lens holder, and the lens-fastening apparatus further comprises a second pressing device located at the rotation guiding plate for pressing a central portion of the rotation-stopping jig.

20. An apparatus as claimed in claim 19, wherein the first pressing device has a first and a second pressing portions for pressing the rotation-stopping jig.
